(19) United States
(12) Patent Application Publication
(10) Pub. No.: US 2007/0146116 A1
(43) Pub. Date: Jun. 28, 2007

(54) Wireless communications device with integrated user activity module

(75) Inventor: Jacob Warren Kimbrell, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/316,427

(22) Filed: Dec. 22, 2005

(51) Int. Cl. G05B 19/00

(52) U.S. Cl. 340/5.52; 340/539.11

(57) ABSTRACT

A wireless communications device comprises a sensor and a processor. The sensor measures a user's performance. The processor monitors the user's measured performance to determine a progress of the user towards the completion of a predetermined objective. Based on the measured performance, the processor selects and renders appropriate multimedia effects to inform the user of their progress. The processor may also render reminder notifications to the user based on data associated with a scheduled event, and activate and de-activate the motion detector based on the scheduled event data.

### BACKGROUND

The present invention relates generally to wireless communications devices, and particularly to wireless communications devices equipped with sensors.

Consumers have come to depend a great deal on their wireless communications devices. Typically, the wireless communications device they choose to purchase may be a function of the number and/or types of features provided with the wireless communications device. Of course, consumer interest in what was once new and innovative often wanes quickly. Therefore, manufacturers consistently try to provide new features and functionality to maintain market share and to entice consumers to purchase their product.

Some wireless communications devices, for example, now come equipped with a sensor such as an integrated pedometer that detects, tracks, and interprets a user's motion. Currently, such devices may count the user's steps and determine the number of calories burned, and display the resulting information to the user. Such devices, however, are limited both in the type of motion that can be detected and in their use. To extend the functionality of wireless communications devices, additional configuration may be needed.

### SUMMARY

A wireless communications device equipped with a sensor such as a pedometer or a biometric sensor, for example, provides a user with feedback based on the user's measured progress in achieving a predetermined objective. In one embodiment, the sensor measures the user's performance. The sensor may be, for example, a pedometer that detects the user's steps or a biometric sensor that detects a biometric characteristic of the user. An application module executing on the wireless communications device monitors and compares the user's measured performance to a predetermined objective. Based on the comparison, the application module selects a complementary multimedia effect stored in memory of the wireless communications device, and renders the selected multimedia effect to coach or encourage the user. Additionally, the application module may, at random or based on the user's performance, select and render a complementary multimedia effect to provide encouragement to the user.

The wireless communications device may also comprise one or more additional application programs that interface with the application module. One such application may be a scheduling or calendar application with which the user may schedule, re-schedule, or alter events, such as daily walks or runs. The application module may access the data associated with a scheduled walk, for example, and use that data to automatically activate and de-activate the motion detector at specified times. In addition, the application module may generate and render reminder notifications to the user based on the accessed data.

### BRIEF DESCRIPTION OF THE DRAWINGS

FIG. 1 is a block diagram illustrating a wireless communications device configured according to one embodiment.

FIG. 2 is a perspective view of an alternate embodiment of the present invention.

FIG. 3 illustrates a logical view of an application module interfacing with other applications on a wireless communications device according to one embodiment of the present invention.

FIG. 4 illustrates a method by which a wireless communications device configured according to one embodiment of the present invention reminds a user of a scheduled event.

FIG. 5 illustrates a method by which one embodiment of the present invention operates.

FIG. 6 illustrates another method by which an alternate embodiment of the present invention operates.

FIG. 7 is a perspective view of another embodiment of the present invention.

### DETAILED DESCRIPTION

The present invention comprises a wireless communications device that measures a user's performance. Based at least in part on the measured performance, the wireless communications device selects a multimedia effect such as a media file. The wireless communications device then renders the selected multimedia effect to coach the user.

As used herein, to “coach” the user means to provide the user with feedback that may or may not be associated with the user's performance in achieving a predetermined objective. The feedback may, for example, offer positive encouragement to the user. Additionally, the feedback may be firm or demanding, or may be “neutral” information based feedback.

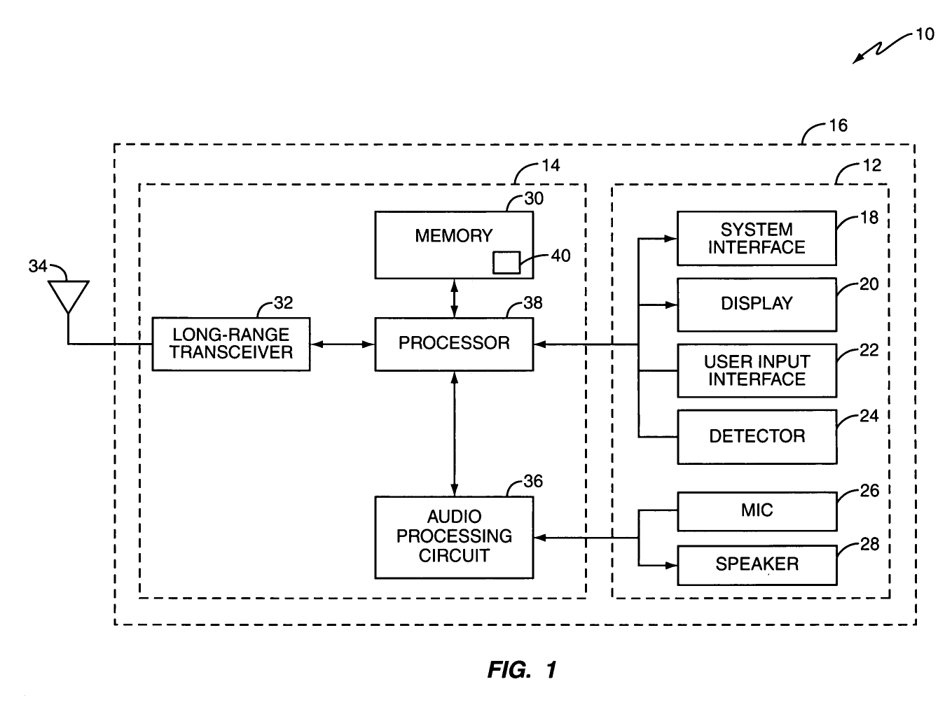

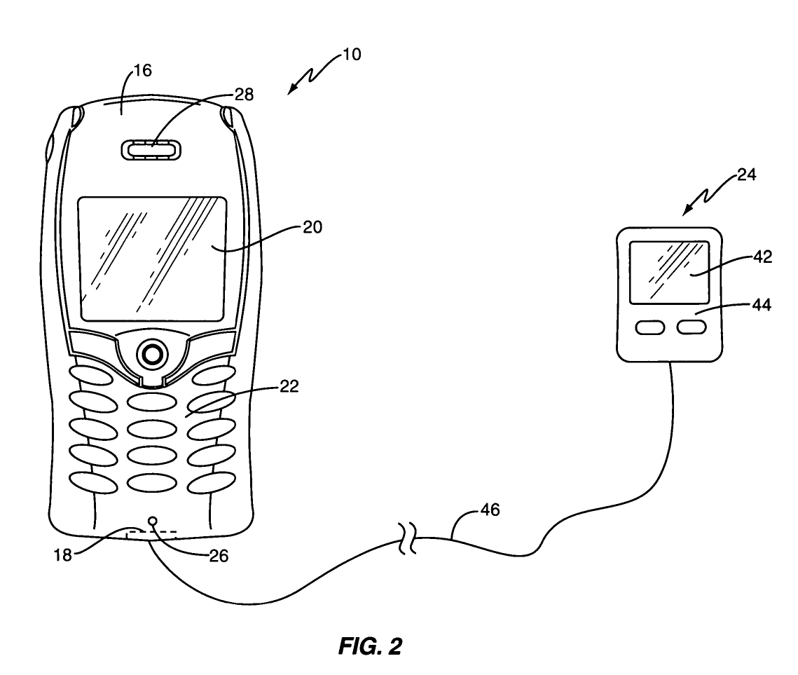

Turning now to the drawings, FIG. 1 illustrates a wireless communication device 10 configured according to one embodiment of the present invention. Wireless communication device 10 includes a user interface 12 and a communications interface 14 in a housing 16. User interface 12 includes a system interface port 18, a display 20, a user input interface 22, a detector 24, a microphone 26, and a speaker 28. User interface 12 generally permits the user to interact with and control wireless communication device 10. System interface port 18 may comprise a “male” or “female” connector that allows the user to connect wireless communications device 10 with any number of desired peripheral devices. Such devices include, but are not limited to, a hands-free headset (not shown) and an external motion detection device (FIG. 2). Display 20 allows a user to view information such as menus and menu items, dialed digits, images, call status information, output from user applications, text messages, and complementary multimedia effects such as video clips and images.

User input interface 22 may include input devices such as a keypad, touchpad, joystick control dials, control buttons, and other input devices, or a combination thereof. The user input devices 22 allow the user to dial numbers, enter commands, scroll through menus and menu items presented to the user on display 20, and make selections. As described in more detail below, user input interface 22 also allows the user to select and/or configure the operation of a detector 24. Microphone 26 receives and converts audible signals, such as the user's detected speech and other audible sound, into electrical audio signals that may be processed by audio processing circuit 36. Speaker 28 receives analog audio signals from audio processing circuit 36, and converts them into audible sound that the user can hear.

Detector 24 detects user motion. Detector 24 may be located internal to the wireless communications device 10 as seen in FIG. 1, or external to the wireless communications device 10 as seen in FIG. 2. Because detector 24 senses motion, it may require initial and/or periodic calibration by the user. For detectors internal to wireless communications device 10, the user may control and/or calibrate detector 24 using user input interface 22. External detectors 24, however, may include their own display 42 and user interface 44 (FIG. 2) to allow the user to calibrate and/or control the operation of external detector 24. Additionally, for external detectors, a cable 46 may connect detector 24 to wireless communications device 10 via system interface port 18. Alternatively, external detectors may be equipped with a BLUETOOTH interface that allows the external detector to communicate wirelessly over short-distances with a wireless communications device 10 that is also equipped with a BLUETOOTH interface.

In one embodiment, detector 24 comprises a pedometer. As is known in the art, pedometers are motion-sensitive devices having electrical circuits that turn on and off as the user walks. Some pedometers, for example, use a magnetic pendulum that moves back and forth past a magnetic field with each step taken by the user. Other pedometers may detect the impact of the user's foot striking the ground. Regardless of how the pedometer detects the user's step, a digital circuit associated with the pedometer may be activated and deactivated to generate a pulse or signal that may be sent to processor 38.

Communications circuitry 14 includes, inter alia, the components necessary to allow a user to communicate with one or more remote parties via a wireless communications link. Communications circuitry 14 comprises memory 30, a processor 38, an audio processing circuit 36, and a transceiver 32 coupled to an antenna 34.

Memory 30 represents the entire hierarchy of memory in wireless communications device 10, and may include both random access memory (RAM) and read-only memory (ROM), as well as magnetic or optical disk storage. Computer program instructions and data required for operation are stored in non-volatile memory, such as EPROM, EEPROM, and/or flash memory, and may be implemented as discrete devices, stacked devices, or integrated with processor 38. As will be described in more detail later, memory 30 may store an application module 40 that interfaces with detector 24 and/or other application programs stored in memory 30.

Transceiver 32 and antenna 34 allow a user to communicate wireless speech and data signals to and from a base station in a wireless communications network (not shown). Transceiver 32 may be a fully functional cellular radio transceiver that operates according to any known standard, including the standards known generally as the Global System for Mobile Communications (GSM), TIA/EIA-136, cdmaOne, cdma2000, UMTS, and Wideband CDMA. In addition, transceiver 32 may include baseband-processing circuits to process the transmitted and received signals. Alternatively, however, baseband-processing circuits may be incorporated in processor 38.

Processor 38 controls the operation of wireless communications device 10 according to programs and/or data stored in memory 30. The control functions may be implemented in a single microprocessor or in multiple microprocessors. Suitable processors may include, for example, both general purpose and special purpose microprocessors. Processor 38 may interface with audio processing circuit 36, which provides basic analog output signals to speaker 28 and receives analog audio inputs from microphone 26. In addition, processor 38 may also execute various user applications stored in memory 30.

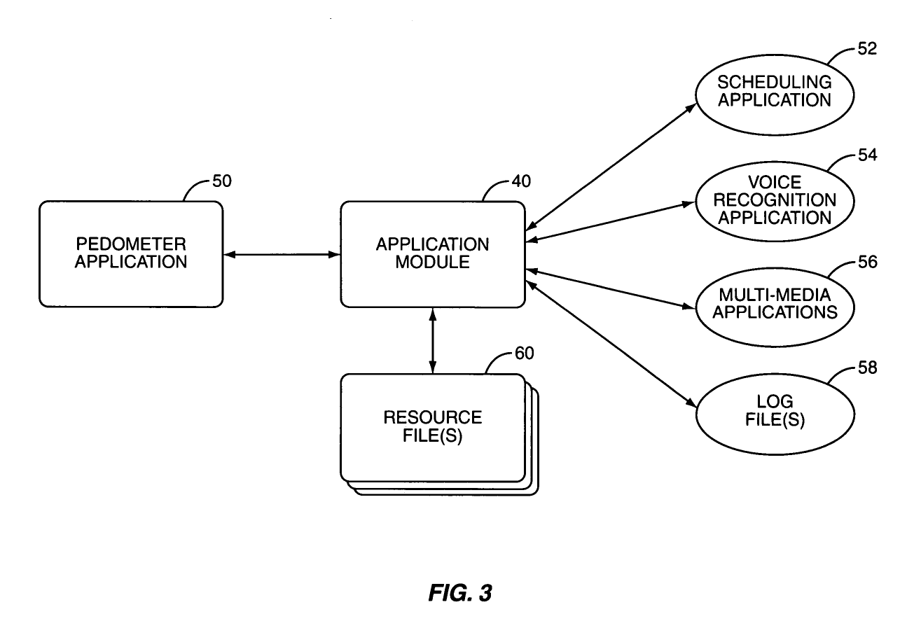

FIG. 3 illustrates some examples of the application programs that may execute on processor 38. One such program is application module 40. Application module 40 extends the functionality of detector 24 by interfacing with detector 24 and one or more these application programs. Application module 40 also provides the user with the ability to manage the operation of the detector 24 in a manner not currently available in conventional detector-equipped wireless communications devices 10. Management of the detector 24 operation may be automatic in some embodiments, and therefore, not require user interaction. In addition, application module 40 may calculate, store, render, and manage data responsive to the output of detector 24.

As seen in FIG. 3, application module 40 may interface with an application program that is associated with detector 24. In the present embodiment, detector 24 comprises a pedometer and thus, application module 40 could interface with a pedometer application 50. Application module 40 may also interface with a scheduling application 52, a voice recognition application 54, and one or more multimedia applications 56. Application module 40 may also write data to one or more log files 58, and operate according to parameters and other information retrieved from one or more resource files 60.

Pedometer application 50 receives signals from the detector 24 responsive to the user's motion. Particularly, the detector 24 may detect when the user takes a step and generate a signal to pedometer application 50. Upon receipt, pedometer application 50 may send a corresponding signal or other indication of the detected step to application module 40 for further processing.

Scheduling application 52 may comprise any type of scheduling or calendar software known in the art, such as a calendar application for example. Typically, the scheduling application 52 maintains the user's schedule of events such as a user's scheduled exercise sessions (e.g., a walk). In one embodiment, for example, the user may enter data associated with a walk or run that the user takes on a periodic basis. The data might include start and end times, dates, whether the walk is a recurring event (e.g., daily), and other information. In one embodiment, the application module 40 may access this data automatically and activate the detector 24 during the specified times, or use the data to generate a reminder notification to the user. In another embodiment,the application module 40 may prompt the user to access the data and activate the detector 24. The application module 40 may then collect and process the data during the scheduled exercise session to generate metrics associated with the user's motion.

The voice recognition application 54 is electrically coupled to microphone 26 and contains logic that converts the user's audible speech into electrical signals for storage in memory 30. While not specifically shown in the figures, the voice recognition application 54 may comprise a speech recognition engine and one or more speech libraries to recognize and digitize the user's voice. According to one embodiment, the application module 40 may interface with the voice recognition application 54 to allow the user to record one or more phrases for storage in memory 30. During a scheduled exercise session, the application module 40 may select one or more of these recorded phrases for playback to the user based in part on the determined progress of a user.

The multimedia applications 56 may be, for example, one or more applications that render complementary multimedia effects to the user. Suitable complementary multimedia effects include, but are not limited to, music associated with playlists, video, images, and tactile functionality. In one embodiment, the application module 40 may generate a signal to cause a multimedia application 56 to render a selected multimedia effect to the user based in part on a determination of the user's progress.

Application module 40 also writes to and maintains one or more log files 58. In one embodiment, the application module 40 writes the metrics collected during a particular scheduled exercise session to the log files 58. For example, the metrics may include the number of paces the user took during the session, and/or the number of calories burned during the session. The application module 40 may also write other information to the log files 58, such as the date, time, duration, and name of an exercise session based on data received from the scheduling application 52. The user may analyze this logged information to determine his or her progress over a period of time.

The resource files 60 include information such as user preferences, configuration information, predetermined objectives that the user wishes to achieve with respect to one or more scheduled exercise sessions, and the like. For example, the information may include the location where the log files 58 are maintained, preferred play lists of songs to be rendered during an exercise session, or one or more pre-recorded phrases that are to be rendered to the user based on the user's current level of activity. The information may also include a certain pace that the user should maintain over a period of time, or a number of calories the user desires to burn. Other information may also be stored in the resource files 60.

Application module 40 may communicate with the applications 50, 52, 54, 56 over one or more interfaces using any method known in the art. In one embodiment, application module 40 communicates with one or more of the applications 50, 52, 54, 56 using one or more Application Programming Interfaces (APIs). APIs are a set of functions and procedures associated with an application that allow other applications access to its functionality and data. The APIs may be the same or different for each of the applications 50, 52, 54, 56. Application module may use these APIs to send and receive data and other information to/from the applications 50, 52, 54, 56. Additionally, application module 40 may communicate with the applications 50, 52, 54, 56 by sending and/or receiving generated signals to/from one or more of the applications 50, 52, 54, and 56. In some embodiments, application module 40 may communicate with the applications 50, 52, 54, 56 using a combination of API calls and generated signals.

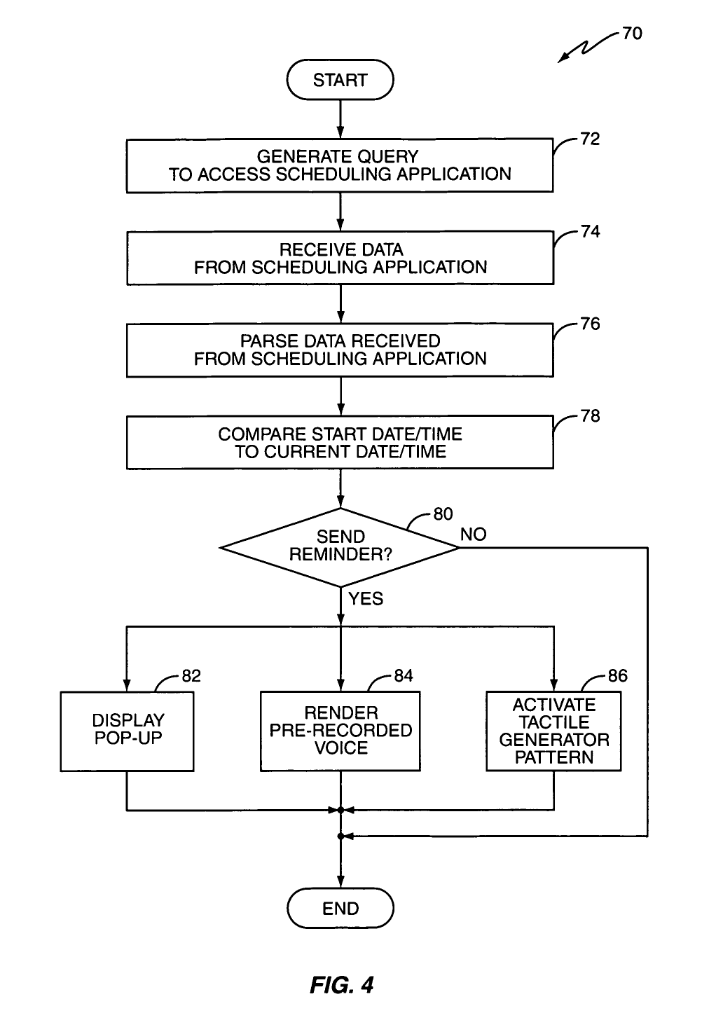

As seen in FIG. 4, for example, the application module 40 communicates with the scheduling application 52 to determine if the user has scheduled an exercise session, and sends the user a reminder notification regarding the session. In this embodiment, the user has already defined an exercise session in the scheduling application 52 as being a walk that the user takes at the same time every day.

Method 70 begins with the application module 40 generating and sending a query to access the data associated with upcoming scheduled exercise sessions to the scheduling application 52 (box 72). The application module 40 may automatically generate the query, or generate the query responsive to user input. Alternatively, the scheduling application 52 may send the data associated with an upcoming scheduled exercise session to the application module 40. The scheduling application 52 retrieves the requested data and returns it to the application module 40 (box 74). The data may include, for example, a name or other indicator that identifies the upcoming session (e.g., “Daily Walk”), the date, the start time, and the end time of the session. Other information may be included as needed or desired.

Upon receipt of the data, the application module 40 parses the information to determine when the session is to begin (box 76), and compares the scheduled start time with the current time (box 78). If the difference between the start time received from the scheduling application 52 and the current time is less than or equal to some predefined threshold (e.g., 15 min), the application module 40 may generate and render a reminder notification to the user (box 80). In one embodiment, for example, the application module 40 displays a pop-up dialog for the user (box 82) indicating that the user daily walk is about to begin. In another embodiment, the application module 40 renders a selected pre-recorded voice message stored in memory 30 through the speaker 28 (box 84). The voice message may be “You have 15 minutes until you begin your daily walk.” In other embodiments, the application module 40 may activate a tactile function generator within the wireless communications device 10 to render a predetermined tactile function pattern (box 86). Once an initial reminder notification has been sent by application module 40, the event data may be saved and used to generate and send successive reminder notifications.

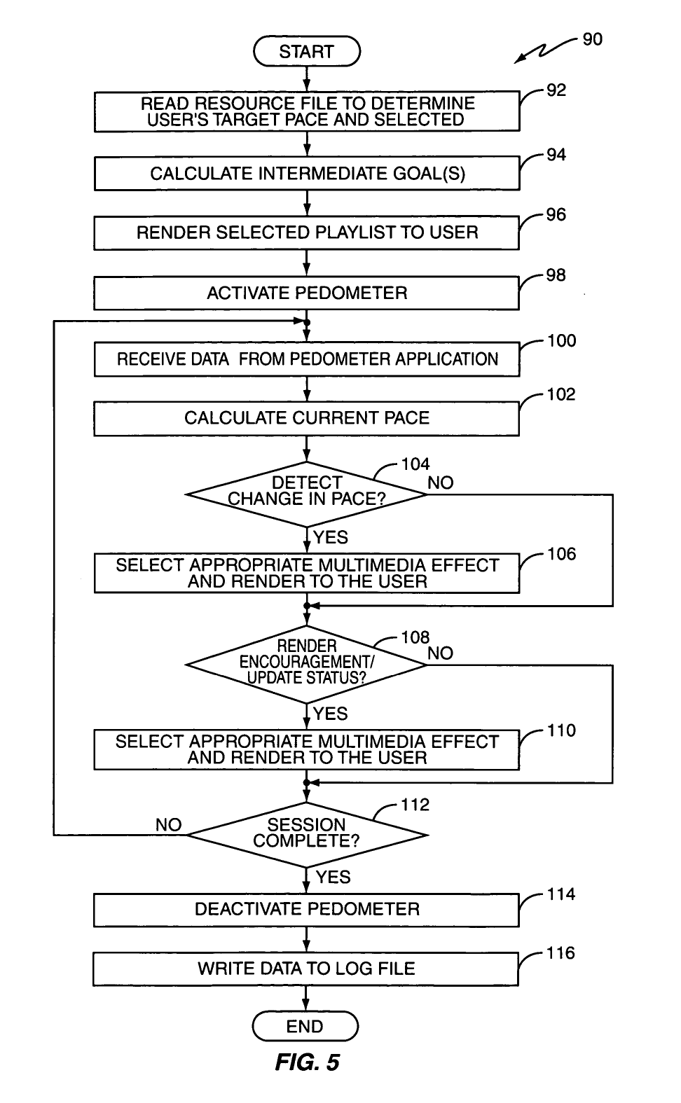

FIG. 5 illustrates a method 90 by which the application module 40 may operate to extend the functionality of detector 24 during an exercise session, such as the daily walk of FIG. 4. In this embodiment, the user has scheduled a walk and set a predetermined objective to maintain a desired pace.

The method 90 begins when the application module 40 detects that the user's scheduled walk will begin, for example, as illustrated in FIG. 4. The application module 40 may access the resource files 60 to retrieve the desired pace the user wishes to maintain (e.g., 6000 steps in 60 minutes) and other user preference information (box 92). Based on this information, the application module 40 calculates one or more intermediate objectives that will be used during the walk to monitor the user's performance. For example, the application module 40 may calculate that the user will need to maintain a pace of 100 steps per minute to achieve the desired predetermined objective of 6000 steps in 60 minutes. In addition, the application module 40 may also retrieve the name of a selected play list from the resource files 60 that the user wishes to hear while walking. Where the user defines a play list, the application module 40 may generate a control signal to the processor 38 to cause the music to start playing through the speaker 28 or through a set of headphones (not shown) connected to the wireless communications device 10 (box 96).

The application module 40 may generate a control signal to the processor 38 to activate the detector 24, which in this embodiment is a pedometer (box 98). In use, the user wears the wireless communications device 10 on his or her body. The pedometer application 50 sends an indication from the pedometer application 50 each time the user takes a step (box 100). The application module 40 receives the indication and increments a value to track the number of steps the user has taken. Periodically (e.g., once per minute), the application module 40 calculates the user's progress by comparing the number of steps taken so far to the previously calculated one or more intermediate objectives (box 102). If the application module 40 detects a change in the user's pace, it may generate a signal to processor 40 to render a multi media effect to the user.

For example, if the application module 40 detects that the user has fallen below the 100 step per minute pace (box 104), the application module 40 will select an appropriate multi media effect and render it to “coach” the user (box 106). By way of example, the application module 40 may generate a signal that causes the processor 38 to render an audible voice message to the user that says, “You had better pick up the pace!” Conversely, if the application module 40 detects that the user's pace as not fallen below the 100 step per minute pace (box 104), the application module 40 may generate a signal that causes the processor 38 to render an audible voice message such as, “Keep up the good work!” The user may pre-assign specific voice messages to be rendered, or application module 40 may dynamically select a voice message based on the user's detected current progress. Where the user is listening to music from the playlist, the application module 40 may generate a signal to suspend playing the music to render the complementary multimedia effect. Once the effect has been rendered, the application module may generate a signal to resume playing the music for the user.

The application module 40 may also periodically render multimedia effects simply to the user to render encouragement (e.g., “C'mon! You can do it!”) or to update the user on his or her status (e.g., “You are halfay there!”) (box 108). The application module 40 may select an appropriate multimedia effect based on information derived from the resource files 60, or the user's current performance, for example (box 110).

Periodically, the application module 40 will check to determine whether the scheduled walk is over by comparing the current time to the end time received in from the scheduling application 52 (box 112). If so, the application module 40 may generate a signal to processor 38 to cause it to deactivate the pedometer (box 114) and write the total number of steps taken by the user to the log file 58 (box 116).

It should be noted that calculating the intermediate objectives may also be based on user input. In one embodiment, application module 40 may present the user with an interface on the display 20 that prompts the user to manually enter the information. In another embodiment, the application module 40 may prompt the user to characterize how strenuous a particular exercise session should be. In these latter cases, application module 40 may automatically generate a predetermined objective and/or one or more intermediate objectives based on the user's characterization. The application module 40 may consider the user's age, weight, level of fitness, and other desired factors in determining objectives appropriate for the specified level.

In addition, where the predetermined objective stretches over a plurality of exercise sessions (e.g., 100,000 paces per week), the application module 40 may also retrieve the historical data from the log files 58 to determine how much of the predetermined objective the user has already achieved. The application module may consider this historical data when computing subsequent intermediate objectives for subsequent exercise sessions. Additionally, the application module 40 may determine the need for subsequent exercise sessions based on the historical data and/or the user's progress, and interface with the scheduling application 52 to schedule new sessions for the user. Further, the application module 40 may interface with the scheduling application 40 to alter data associated with existing scheduled sessions based on the user's progress.

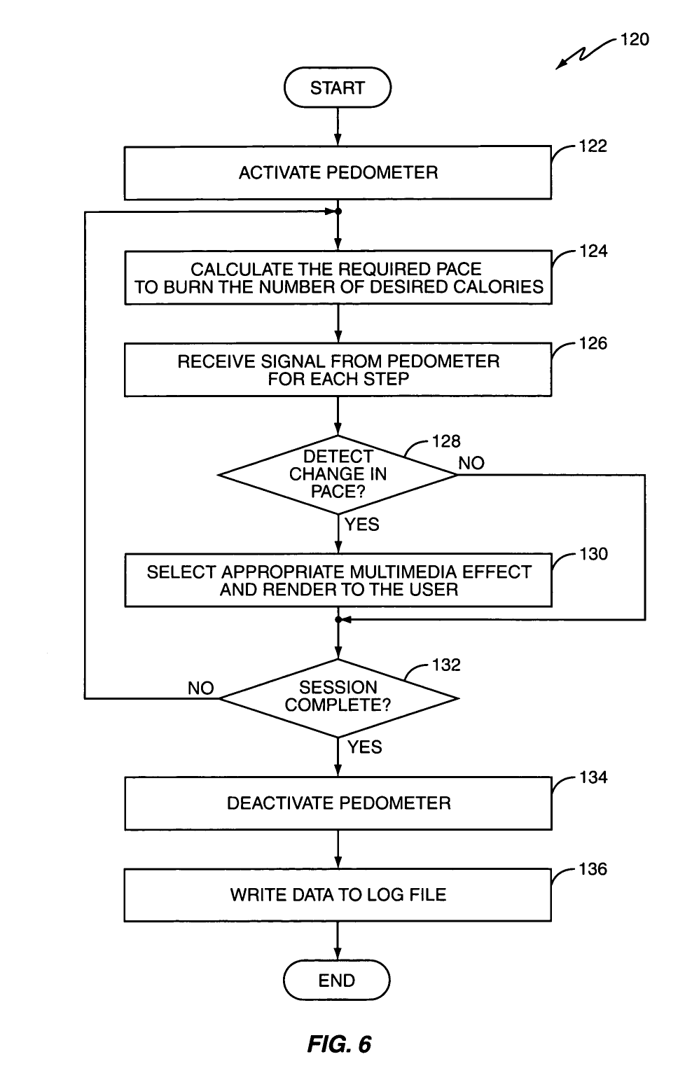

FIG. 6 illustrates another method 120 where the application module 40 tracks the number of calories the user burns during a walk. In this embodiment, the application module 40 receives signals directly from the detector 24 (e.g., a pedometer) rather than receiving them indirectly via pedometer application 50.

As in the previous embodiment, the application module 40 retrieves the predetermined objective set by the user, which for illustrative purposes only, is a desired number of calories to burn (e.g., 1000 calories). As previously mentioned, the application module may retrieve the predetermined objective from the resource file 60. The application module 40 then generates a control signal to activate the pedometer to begin measuring the user's performance (box 122). The application module 40 also calculates the one or more intermediate objectives for the user that will be used to gauge the user's progress. For example, the application module may determine a pace that the user must maintain to burn the desired number of calories (box 124). Application module 40 may also perform other calculations to determine the number of calories the user must burn over a period of time (e.g., 10 minutes) to achieve the user's predetermined objective. The calculations may be based on information stored in the resource file 60 regarding the user's age and weight, for example.

During the walk, the application module 40 receives signals from the detector 24 that indicates user steps (box 126), and periodically determines whether the user is maintaining the required pace or burning the required number of calories (box 128). As above, the application module tracks the user's progress, and may compare a value indicative of the user's progress to the intermediate objective. Based on this comparison, the application module 40 may select an appropriate multimedia effect (e.g., a voice message) from memory 30 and render it to the user (box 130). The particular selected multimedia effect may be a voice message that indicates to the user the number of calories the user has burned during the session, how much of the exercise session has elapsed or that the user should alter his or her pace. When the scheduled walk is complete (box 132), the application module 40 deactivates the detector 24 (box 134) and writes the total number of calories burned and/or the total number of steps taken to the log file 58.

It should be noted that the application module 40 may be configured to dynamically select and render an appropriate multi media effect based in part on the user's current progress, or at random to provide encouragement to the user. The multi media effect may offer positive encouragement to the user (e.g., C'mon! Keep up the good work! You're almost there!”), or may offer more stern encouragement when the user is not meeting expectations (e.g., “Start Hustling! You are getting slower!”). The messages may be the user's own voice recorded using voice application 54, or may be other prerecorded voice messages downloaded from an external server. Where the user is listening to music, the application module 40 will generate a control signal to temporarily interrupt the music and render the voice message. Once the voice message has been rendered, the application module 40 will generate another control signal to resume playing the music.

The user may categorize each pre-recorded message according to its content. For example, the user may store voice messages indicating that the user is achieving the intermediate objectives in a first location in memory 30, and other voice messages indicating the user is not achieving the intermediate objectives in a second location in memory 30. Other “neutral” information-based voice messages indicating a remaining duration for the session, for example, may be stored in a third location. The application module 40 will dynamically select a message from an appropriate location based in part on the user's monitored progress.

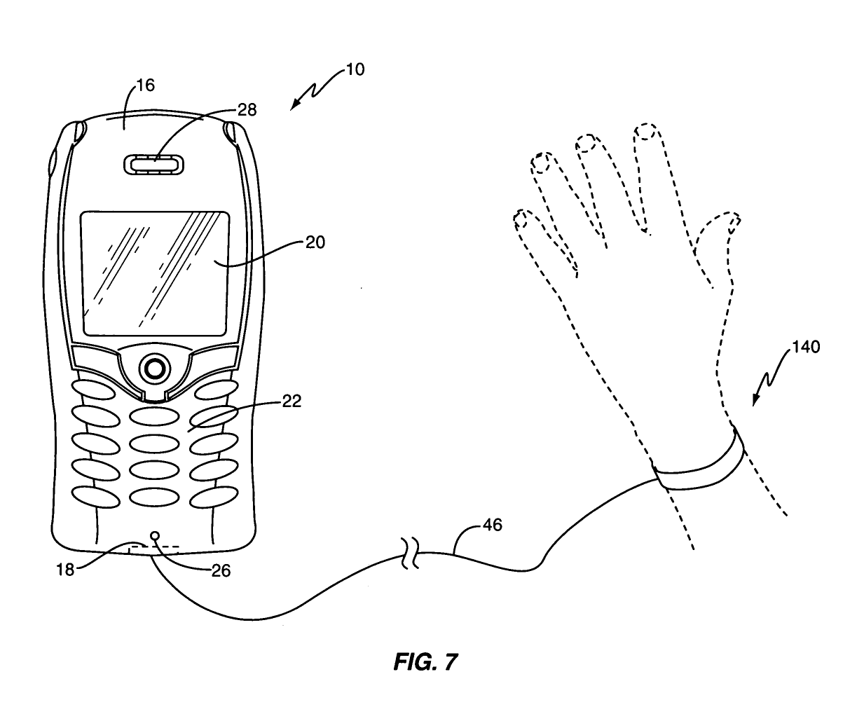

FIG. 7 illustrates another embodiment of the present invention where the a biometric sensor 140 measures a biometric characteristic of the user. This biometric characteristic is used to measure the user's performance towards achieving a predetermined objective.

In FIG. 7, biometric sensor 140 comprises a band worn around the user's wrist, and connects to the system interface port 18 of the wireless communications device 10 via cable 46. Alternatively, the biometric sensor 140 could communicate with the wireless communications device via a BLUETOOTH interface. The biometric sensor 140 may comprise one or more sensors or detectors that monitor the user's heartbeat. The biometric sensor 140 may generate signals representing the user's heartbeat and send the signals to the application module 40. The application module 40 monitors may calculate the user's heart rate based on these received signals. The application module 40 may also compare the calculated heart rate to a predetermined objective, such as a range within which the user desires to maintain his or her heart rate (e.g., 140-160 beats per minute). In addition, the desired range may be time-bound (e.g., maintain 140-160 beats per minute for 1 hour). If the user's calculated heart rate falls outside of the desired range, the application module 40 may select and render an appropriate media file as described above. Additionally, the application module 40 may select and render appropriate media files while the user's heart rate stays within the desired range.

The biometric sensor 140 could also measure other biometric characteristics of the user in addition to or in lieu of the user's heart rate. For example, the biometric sensor 140 could include sensors that sense the user's body temperature. In these cases, the user might wish to maintain his or her body temperature within a certain range. As above, application module 40 could select and render appropriate multimedia effects based on whether the user's body temperature stays within the desired range. In addition, the biometric sensor 140 need not be embodied as a wristband. In some embodiments, for example, the biometric sensor 140 comprises a clip or ring that connects to the user's ear or finger. In other embodiments, the biometric sensor 140 could be sized to be worn around another part of the user's body, such as the user's chest, or may be an “implant” within the user's body. Further, the biometric sensor 140 in FIG. 7 is shown as being an external device. Those skilled in the art will understand that biometric sensor 140 may be contained within the housing of the wireless communications device 10.

The specification and the drawings illustrate the wireless communications device as being a cellular telephone. However, those skilled in the art will readily appreciate that this is merely for illustrative purposes. As used herein, the term “wireless communication device” may include a cellular radiotelephone, a Personal Communication System (PCS) terminal, a Personal Digital Assistant (PDA) that can include a radiotelephone, Internet/intranet access, web browser, organizer, calendar, and/or a global positioning system (GPS) receiver, a conventional laptop and/or palmtop receiver, or other appliance or mobile station that includes a radiotelephone transceiver.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of providing a user of a wireless communications device with performance-based feedback, the method comprising:
receiving data from a scheduling application executing on a user's wireless communications device that indicates a scheduled exercise activity associated with the user, the wireless communications device being configured to transmit and receive wireless signals with a remote party via a wireless communications network
using a sensor associated with the wireless communications device to measure a user's performance during a scheduled exercise activity;
comparing the measured performance of the user to a predetermined objective;
selecting a media file stored in memory of the wireless communications device based on the comparison; and
rendering the selected media file to coach the user.

2. The method of claim 1 wherein using a sensor to measure a user's performance comprises detecting the user's motion using a motion detector.

3. The method of claim 1 wherein using a sensor to measure a user's performance during exercise comprises using a biometric sensor to measure a biometric characteristic of the user.

4. The method of claim 1 wherein using a sensor to measure a user's performance comprises:
receiving successive indications of the user's performance from the sensor; and
maintaining a value representing the measured performance responsive to the successive indications.

5. The method of claim 1 further comprising:
selecting a second media file stored in memory of the wireless communications device independent of the user's measured performance; and
rendering the selected media file to coach the user.

6. The method of claim 1 further comprising calculating the predetermined objective based at least in part on historical data representing one or more previously measured performances of the user.

7. The method of claim 1 wherein selecting a media file stored in memory of the wireless communications device based on the comparison comprises:
selecting a first pre-recorded voice file if the comparison indicates that the user achieved the predetermined objective; and
selecting a second pre-recorded voice file if the comparison indicates that the user did not achieve the predetermined objective.

8. (canceled)

9. The method of claim 1 further comprising generating an activation signal to activate the sensor based on a start time of the scheduled exercise event.

10. The method of claim 9 further comprising generating a de-activation signal to de-activate the sensor based on the end time of the scheduled exercise event.

11. The method of claim 9 further comprising generating a reminder notification based on the start time of the scheduled exercise event, and rendering the reminder notification to the user.

12. The method of claim 11 further comprising re-scheduling the exercise event responsive to user input.

13. The method of claim 1 further comprising rendering a selected play list stored in memory of the user's wireless communications device during exercise.

14. The method of claim 1 further comprising saving the user's measured performance to a log file stored in memory of the wireless communications device.

15. The method of claim 1 further comprising activating and deactivating the sensor based on user input.

16. A wireless communications device comprising:
a transceiver to transmit and receive wireless communications signals to a remote party;
a controller; and
an application module executed by the controller, the application module including logic configured to:
access data associated with a scheduling application executing on the wireless communications device, the data indicating a scheduled exercise event associated with the user;
monitor a measured performance of the user during the scheduled exercise event to determine the user's progress toward achieving a predetermined objective;
select a multimedia effect stored in memory of the wireless communications device based at least in part on the measured performance of the user; and
render the selected multimedia effect to coach the user.

17. The device of claim 16 further comprising a sensor communicatively connected to the controller to measure the performance of the user.

18. The device of claim 17 wherein the sensor comprises a motion detector that detects the user's motion.

19. The device of claim 18 wherein the motion detector comprises a pedometer.

20. The device of claim 17 wherein the sensor comprises a biometric sensor that monitors a biometric characteristic of the user.

21. The device of claim 20 wherein the biometric sensor monitors the user's heart beat.

22. The device of claim 20 wherein the biometric sensor monitors a body temperature of the user.

23. The device of claim 16 wherein the application module further includes logic configured to calculate the predetermined objective based on one or more previously measured performances of the user.

24. The device of claim 16 wherein the application module further includes logic configured to select a first multimedia effect if the user's monitored progress indicates that the user is achieving the predetermined objective, and a second multimedia effect if the user's monitored progress indicates that the user is not achieving the predetermined objective.

25. The device of claim 24 wherein at least one of the first and second multimedia effects comprises a pre-recorded voice file.

26. (canceled)

27. The device of claim 16 wherein the application module further includes logic configured to monitor the user's measured performance based on the data associated with the scheduling application.

28. The device of claim 27 wherein the data associated with the scheduling application comprises a start time, and wherein the application module further includes logic configured to cause the controller to activate the sensor based on the start time.

29. The device of claim 28 wherein the data associated with the scheduling application further comprises an end time, and wherein the application module further includes logic configured to cause the controller to de-activate the sensor based on the end time.

30. The device of claim 16 wherein the application module further includes logic configured to generate a reminder notification to the user based on the data associated with the scheduling application.

31. The device of claim 30 wherein the reminder notification comprises a pop up dialog.

32. The device of claim 30 wherein the reminder notification comprises a pre-recorded voice file.

33. The device of claim 30 wherein the reminder notification comprises a pre-determined tactile function pattern.

34. The device of claim 16 further comprising a speaker, and wherein the application module further includes logic configured to cause the controller to render a selected play list stored in the memory to the user over the speaker while monitoring the measured performance of the user.

35. The device of claim 16 wherein the application module further comprises logic to receive signals generated by the sensor.

36. The device of claim 35 wherein the application module further comprises logic to interface with a first application module associated with the sensor to receive the generated signals.
